(19) United States
(12) Patent Application Publication
(10) Pub. No.: US 2013/0189493 A1
(43) Pub. Date: Jul. 25, 2013

(54) REFRACTORY LINING ARTICLE AND SYSTEM

(71) Applicant: Stellar Materials Incorporated, Boca Raton, FL (US)

(72) Inventor: Jens Decker, Ann Arbor, MI (US)

(73) Assignee: Stellar Materials Incorporated, Boca Raton, FL (US)

(21) Appl. No.: 13/786,810

(22) Filed: Mar. 6, 2013

Related U.S. Application Data
(63) Continuation-in-part of application No. 13/636,968, filed on Nov. 9, 2012.
(60) Provisional application No. 61/316,602, filed on Mar. 23, 2010.
(60) Provisional application No. 61/737,163, filed on Dec. 14, 2012.

(51) Int. Cl. F27D 1/00

(52) U.S. Cl. CPC F27D 1/0006
USPC 428/172; 156/60; 156/71; 428/702; 428/446; 428/701; 428/699; 428/189; 428/192

(57) ABSTRACT

Processes of forming or repairing a structure used in a high temperature application are provided whereby a refractory article lining that is glazed on a face closest to a structure wall is used to form or replace a portion of the refractory surface in such a structure. The refractory articles may be chemically and/or mechanically bonded to an adhesive mortar capable of chemically reacting with the material used to form the brick to form a high strength, substantially monolithic surface that resists penetration by flux salts dramatically increasing the life of the repair. The process allows for low cost, long lasting repair of structures used in high temperature applications that was previously unrealizable. Also provided are refractory articles with a glaze coating on at least a portion thereof that prevents flux salt penetration. The refractory articles are optionally used in a system along with a complementary adhesive mortar.

### CROSS REFERENCE TO RELATED APPLICATIONS

This application is a continuation-in-part of and claims priority to U.S. patent application Ser. No. 13/636,968, which is a U.S. National Stage of PCT application PCT/US 2011/029416 filed Mar. 22, 2011, and which claims priority from provisional 61/316,602 filed Mar. 23, 2010; and this application also claims priority to U.S. Provisional Application No. 61/737,163, filed Dec. 14, 2012.

### FIELD OF THE INVENTION

The present invention relates in general to a refractory system. In particular a refractory system and processes of its use as provided herein form a maintenance friendly and protective substantially monolithic surface useful in a wide array of high temperature applications. A refractory system as provided is easily replaced, or is used to replace a worn or damaged refractory surface, and is protective to underlying vessel materials thereby prolonging the useful life of a high temperature vessel.

### BACKGROUND OF THE INVENTION

High temperature vessels used for molten metal or material incineration are lined with refractory materials to contain the heat of the internal space or contents. Such refractories must not only be capable of resisting thermal stresses, but must also be resistant to chemical and physical wear.

Typical refractories are installed as previously fired brick linings, cast in situ as monolithic materials or are provided as pre-cast shapes that have been fired prior to installation. Each of these prior systems suffers significant drawbacks. Brick linings require skilled labor and a relatively long installation times. While the pre-fired bricks themselves can withstand furnace conditions often better than cast in place monolithic linings, brick systems suffer weakness at mortar joints that wash out during operation resulting metal infiltration and subsequent spalling due to high stresses in the lining. Thus, traditional brick systems commonly require extensive maintenance and increased construction costs.

Refractory materials that are cast in place often require difficult and time intensive formwork installation. Following installation several days are consumed for the required dry-out and heat-up due to the water content in the installed materials. These in situ cast linings also commonly suffer from shrinkage during dry-out combined with cracking that can cause metal infiltration and premature degradation of both the lining and the underlying vessel shell.

Pre-cast shapes, in contrast to in situ systems, are pre-fired and as a consequence do not suffer additional shrinkage or cracking in operation. Also, the heat up process is shorter because water has been removed during the pre-firing step. However, large pre-cast shapes are heavy and difficult to install. In particular the “big block” technology requires an open furnace roof in order to move the large and several thousand pound blocks into a furnace. In addition the joints between the blocks are relatively large and have limits regarding fast heat-up. These joints are also prone to metal infiltration during operation.

Another common problem with industrial furnaces is non-uniform wear. For instance, aluminum melting furnaces require regular maintenance every 6 months to 18 months. Typical wear areas are the belly-band, sill, ramps and jambs. Repair or replacement of the refractory materials in these wear areas are difficult and costly. For example, replacing individual bricks in a bricked wall structure or patching a worn out belly band area of a monolithic big block shape is virtually impossible to do successfully using prior refractory systems. This is particularly true if the belly band is deeply infiltrated with flux salts. Repair patching with refractory materials alone, for example, is often unsuccessful due to subsequent salt melting underneath the path repair causing the patch to break off. It is not uncommon that newly relined furnaces show serious spalling damage after only a few months of post repair operation. No known prior system is available to perform long lasting repairs that guarantee the expected lifetime and reasonable return on the investment.

As such, there is a need for improved refractory systems that can be used in the formation of a refractory surface and allow successful repair of a portion of or the entire surface of a high temperature vessel that is cost effective, long lasting, and resistant to degradation.

### SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

The above issues with prior materials and systems for repair of a worn or damaged refractory surface, such as a lining of a high temperature vessel, are addressed by the processes, refractory articles, and systems of the present invention. The use of a cementitious refractory article coated with a glaze material, along with a complementary adhesive mortar that will form a chemical bond to the refractory article, creates a substantially monolithic refractory surface that is resistant to degradation from flux salts penetrating the refractory material, provides a long lasting repair, is itself easily replaced, and represents a very cost effective solution to the long felt need for a system and materials for repair of high temperature vessels.

A coated refractory article is provided that can be used to line the high temperature inner surface of a high temperature vessel in whole or in part. A refractory article includes a phosphate bonded cementitious refractory material forming a shape having a first face, a second face opposite the first face, and a glaze, the glaze contacting and overlayering at least a portion of the second face of the refractory material. A refractory material may be made from a combination of a plurality of aggregate ceramic particles and a binder sintered to the plurality of aggregate ceramic particles, where the binder optionally includes crystalline aluminum orthophosphate distributed in the binder as the result of reaction of aluminum metaphosphate with alumina. The aggregate of ceramic particles is optionally bauxite, silicon carbide, fumed silica, or mullite. A refractory article optionally also includes a filler, optionally steel fibers. Some embodiments of a refractory article also include a nonfacile additive such as calcium aluminate cement, sodium silicate, polyphosphate, or organic salts.

A refractory article includes a glaze material coating at least a portion of a second side. The glaze material optionally includes silica, a metal oxide, alumina, a silicon carbide, or combinations thereof The glaze material optionally has a melting point at or above 1850 degrees Fahrenheit. A glaze material optionally coats less than the entire surface of the article.

A refractory article has a defined shape that optionally includes a first edge and a second edge, where the first edge includes a contour feature, and the second edge includes a complementary feature. The article has a thickness, optionally between 0.5 to 8 inches. An edge optionally has a length of 6 to 36 inches. A second surface optionally includes one or a plurality of indentations optionally having a depth of less than one inch.

The refractory articles in any configuration of elements are optionally included in a refractory system that further includes a phosphate cement based adhesive mortar. The adhesive mortar optionally includes a phosphate based component of calcium, phosphate, phosphoric acid, potassium phosphate, sodium phosphate, aluminum phosphate, ammonium phosphate, zinc phosphate, magnesium phosphate, or combinations thereof, alone with an alkali earth ion component. The alkali earth ion component optionally includes magnesium oxide, a combination of magnesium oxide and calcium aluminate, or a calcium aluminate calcium ion source. A strength enhancing insoluble phosphate, optionally boron phosphate, is optionally included in the adhesive mortar.

Also provided are processes of forming or repairing a structure for use in high temperature applications. Optionally, any of the coated refractory articles above or herein, any of the adhesive mortars above or herein, or the systems presented herein may be used in a process in any configuration and modifications thereof that are understood by one of skill in the art. A process includes associating a cementitious refractory article with a structure surface where the cementitious refractory article has a first face and a second face, and where the second face is positioned proximal to the structure surface, and the second face contacting a glaze material that is overlayering at least a portion of the second face. In particular embodiments, the structure surface optionally is located in the belly band area of the structure wall. The step of associating optionally includes contacting an adhesive mortar with the article, the adhesive mortar positioned between the article and the structure wall, and contacting a second side of the article and forming a chemical bond between the article and the adhesive mortar. The process optionally also includes associating a plurality of the cementitious refractory articles edge to edge to create a form that is spaced apart from a surface to form a space, and filling the space with an adhesive mortar thereby contacting the adhesive mortar to the plurality of cementitious refractory articles such that the adhesive mortar and the refractory articles form a chemical bond therebetween. An adhesive mortar useful in the processes is optionally a phosphate cement based adhesive mortar, optionally any phosphate cement based adhesive mortar described as a portion of a system or otherwise. The refractory article used in the process is optionally any of the numerous coated refractory articles of the invention or equivalents thereof in any configuration or combinations of configurations of a coated refractory article.

### BRIEF DESCRIPTION OF THE DRAWINGS

FIG. 1 illustrates a cementitious refractory article alone or as used in a system or process wherein the article is depicted according to one embodiment;

FIG. 2 illustrates one embodiment of a coated cementitious refractory article alone or as used in a system or process.

### DETAILED DESCRIPTION OF EMBODIMENTS OF THE INVENTION

The following description of particular embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the processes or components are described as an order of individual steps or using specific materials, it is appreciated that steps or materials presented herein or their equivalents may be interchangeable such that the description of the invention may include multiple parts or steps arranged in many ways as is readily appreciated by one of skill in the art.

A refractory article is provided that has utility as a repair or virgin component of a high temperature construct such as a vessel, furnace, or kiln. A refractory article provides a protective, refractive barrier between a vessel wall and any contents of a vessel when in use. An article may be associated with other like articles to form a barrier that is resistant to complete penetration by flux salts, is easily replaceable or used to replace existing refractory structures, and increases vessel lifetime relative to existing patch materials and structures.

A refractory article is provided that includes a refractory material and a coating over layering the refractory material on at least one face thereof or portion of the face. The combination of the refractory material and the coating form a barrier that substantially prevents formation or transfer of flux salts to an underlying vessel wall or other underlying structure.

A refractory article includes a first face, a second face, and one or more edges, optionally a plurality of edges. A face includes a cross sectional area. A cross sectional area has a shape that is optionally polygonal such as triangular, square, pentagonal, hexagonal, or other polygon of any number of sides (edges) so as to be interlockable with other cross sectional shapes. In some embodiments, the refractory material is optionally in the shape of a tile, illustratively a rectilinear polygon, such as a square or other suitable shape.

A face includes a cross sectional dimension such that the resulting article is suitably sized so that a refractory article can be carried and installed by one to three persons. A cross sectional dimension is optionally 12 to 36 inches, or any value or range therebetween. In some embodiments, a cross sectional dimension is 24 inches. Optionally a cross sectional dimension is 12, 13, 14, 15, 16, 17, 18, 19, 20, 21, 22, 23, 24, 25, 26, 27, 28, 29, 30, 31, 32, 33, 34, 35, or 36 inches.

A refractory article includes at least one edge. An edge optionally provides a length equivalent to a cross sectional dimension, a portion of a cross sectional dimension, greater than a cross sectional dimension, or to a thickness. An edge has a length that is optionally in some embodiments 12 to 36 inches, or any value or range therebetween. In some embodiments, an edge length is 24 inches. Optionally an edge length is 12, 13, 14, 15, 16, 17, 18, 19, 20, 21, 22, 23, 24, 25, 26, 27, 28, 29, 30, 31, 32, 33, 34, 35, or 36 inches. In some embodiments, a first edge has a first length, and a second edge optionally has a second length. A first edge and a second edge are at an angle relative to the length of each whereby the angle defines the overall shape of the article. Optionally, an angle is 90 degrees such as in a square or rectangular shape.

A cementitious refractory article has a thickness. A thickness is optionally uniform or is variable between edges. A thickness of an article is optionally from 0.5 to 8 inches across, or any value or range therebetween. A thickness is optionally 3 to 5 inches, optionally 3.5 to 4.5 inches, optionally 4 inches. A thickness of an edge is optionally 0.5, 1, 2, 3, 4, 5, 6, 7, or 8 inches. It is appreciated that the thickness combined with the refractory material used in constructing a cementitious refractory article results in a particularly tuned heat penetration profile and article strength. In addition, the thickness combined with the cross sectional dimension results in an article that may be lifted and installed by one to three people. In some embodiments, an article is no larger than that which may be handled by 1 to 3 people, optionally no larger than 36 inches in cross sectional dimension and no thicker than 5 inches.

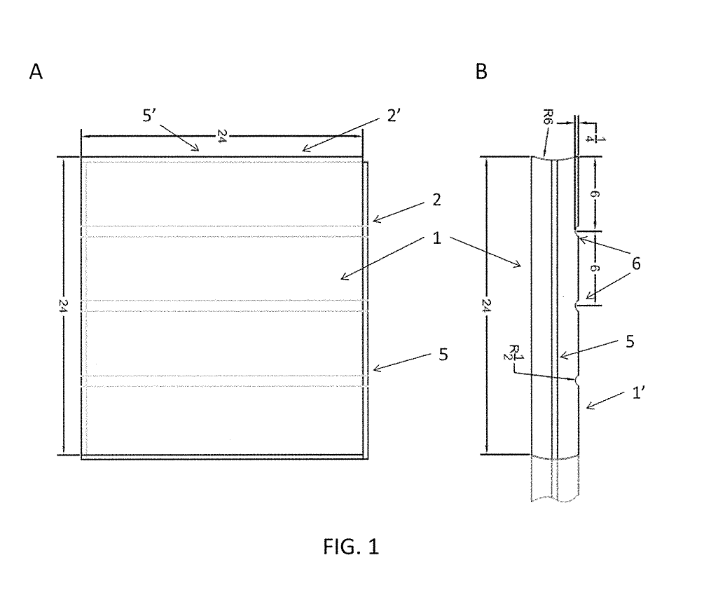

An illustrative embodiment of a refractory article is presented in FIG. 1. FIG. 1A depicts a refractory article with a first face 1, that is bound by a plurality of edges 2, 2′. The embodiment of FIG. 1 is illustrated in the shape of a square face for illustrative purposes alone, and not as a limitation on the overall shape of a refractory article. A first edge 2 is optionally the same or different length relative to a second edge 2. In some embodiments a first edge 2 is from 0.1 to 10 times the length of a second edge 2′. Optionally, a first edge 2 is two times the length of a second edge 2′.

A face 1 is optionally smooth, irregular, or uniformly altering about its surface. FIG. 1B illustrates an article as viewed from an edge 2 illustrating a thickness 4 between a first face 1, and a second face 1′. An edge 2 optionally includes one or more contour features 5 as described in greater detail below. It is further appreciated that an edge 2 optionally is linear or curvilinear between the first face 1 and the second face 1′. A curved edge may be substantially convex or concave and is optionally created to complement a curved edge on an adjacent article such that the articles may be laid over a curved surface or may form a curved surface though their joining while maintaining a tight joint between the edges of adjacent articles. A curved edge optionally defines a radius. An edge radius is optionally between 1 and 10 inches or any value or range therebetween. In some embodiments, an edge radius is from 4 to 7 inches. Optionally, an edge radius is 6 inches.

In some embodiments, a refractory article includes one or more contour features on an edge. The presence of one or more contour features on an edge that compliment an opposing complementary feature on the edge of an adjacent article assists in forming a substantially impermeable barrier to flux salts and serves to strengthen the resulting structure by removing or eliminating the previously required and extensive mortar joints when using bricks for a refractory material. In some embodiments, a contour feature 5 on a first edge 2 is optionally a complementary feature to a contour feature on a second edge 5′. An edge optionally includes a plurality of contoured features, complementary features, or both. Contoured features and complementary features are optionally interdispersed, optionally to form an undulating surface for interlocking with another refractory article or other surface. The number of contoured features or complementary features is optionally 1, 2, 3, 4, 5, 6, or more.

Many different and optionally complimentary contour features are operable for inclusion on an edge. Illustrative examples of a contour feature or complementary feature include dovetails, pin and socket, and other such features conventional to the joinder arts. As such, a contour feature is optionally a tongue (optionally rectilinear or curved), groove (optionally rectilinear or curved), angle so as to optionally form a dovetail joint, pin shape such as a tenon or cylindrical protrusion, or socket shape such as that of a mortise (rectangular or curved).

A first face of a refractory article is optionally intended to face the area or material of high heat, e.g. molten aluminum. A second face is optionally intended to face a vessel wall, or away from the source of highest heat. A second face optionally also includes one or more indentations, optionally a plurality of indentations. The indentation(s) on the second face of an article provide improved adherence to bonding material that will be cast between the article and existing refractory in the vessel or the vessel wall itself by providing a physical association that can be used to complement the chemical association promoted by the adhesive mortar. These indentations on a face are optionally uniformly dispersed or irregularly dispersed over the surface of the face. A plurality of indentations are optionally evenly spaced. The number of indentations is optionally from 1 to 10 or more, or any value or range from 1 to 10. Optionally, the number of indentations is 1, 2, 3, 4, 5, 6, 7, 8, 9, 10, or more. An indentation is optionally linear from one edge to another edge, or any shape such as curve, angled, irregular, circular, or combinations thereof. Optionally, an indentation is a circle, optionally as a plurality of circular indentations that may lie in concentric or non-concentric fashion. An indentation optionally forms a radius, depth, or other dimension at an angle to the plane of the face. An indentation radius or depth is optionally from 0.1 inch to 1 inch, or any value or range therebetween. Optionally a radius or depth of an indentation is optionally less than 1 inch. Optionally, an indentation radius or depth is 0.1, 0.2, 0.3, 0.4, 0.5, 0.6, 0.7, 0.8, 0.9, or 1 inch. FIG. 1B illustrates an exemplary plurality of indentations 6 on a second face 1′.

A refractory article is formed of a cementitious refractory material. Owing to strength properties at elevated temperatures above 1000° Celsius and non-wetting properties relative to molten metals, phosphate bonded cements can be used as a refractory material from which an article is formed. It is appreciated that other cementitious refractory materials can be used to form a refractory article depending on the eventual exposure requirements of the article as well as the nature of the coating present on a face of an article.

In some embodiments, a cementitious refractory article is formed from a cementitious material that includes a plurality of aggregate ceramic particles and a binder sintered to the plurality of aggregate ceramic particles, where the binder includes crystalline aluminum orthophosphate distributed in the binder as the result of reaction of aluminum metaphosphate with alumina. The plurality of aggregate ceramic particles optionally includes bauxite particles. In some embodiments, the plurality of aggregate ceramic particles includes at least one of silicon carbide, fumed silica, or mullite.

With the refractory aggregate containing alumina, Al₂O₃ the aluminum metaphosphate reacts to foam crystalline aluminum orthophosphate, AlPO₄. Aluminum orthophosphate is the thermodynamic product upon heating to a temperature greater than about 580° Celsius with a decomposition temperature of about 1650° Celsius. The resultant cementitious material is amenable to incorporation of reinforcing materials such as steel fibers and is operative with aggregate particulate including silicon carbide, mullite, alumina, titania, and combinations thereof. Such a cementitious material is readily formed with a density of greater than 90% of a theoretical density and cold crush strengths in excess of 88 Newtons per square millimeter. In some embodiments, the theoretical density is from 2200 kg/m³ to 3050 kg/m³. Through control of water content and conventional additives, the cast form of a refractory article has sufficient green strength to be handled and optionally machined prior to firing to provide a refractory article with superior strength and alkali resistance, as compared to conventional materials.

A bindery for a cementitious material optionally includes aluminum metaphosphate that is mixed with aggregate ceramic particles and processed under conditions to afford aluminum orthophosphate as a crystalline binder. The binder aluminum orthophosphate optionally has berlinite as a predominant phase. It is appreciated that aluminum metaphosphate as a binder precursor is amenable to inclusion in a kit to form a refractory article as aluminum metaphosphate is far less hygroscopic as compared to phosphoric acid, more pH neutral (around pH 5) and is commercially available in a variety of particle mesh sizes. The reaction of aluminum metaphosphate with alumina (synonymously termed bauxite herein) to form a crystalline binder phase of aluminum orthophosphate (synonymously referred to herein as berlinite) is detailed with respect to the following equation:

Al(PO₃)₃+Al₂O₃→3 AlPO₄ (I)

Aluminum orthophosphate appears to be a thermodynamically stable phase that is formed upon heating the reagents to a temperature above about 580° Celsius. Aluminum orthophosphate is noted to have a decomposition temperature of about 1650° Celsius at ambient pressure. It is appreciated that the formation temperature of aluminum orthophosphate varies according to predictable thermodynamic relationships when the reaction proceeds at pressures other than atmospheric pressure. It is appreciated that formation of a refractory article according to the present invention readily occurs through firing the green foim of an article through hot isostatic pressing (HIP). It is appreciated that a mixed metal orthophosphate is readily formed according to the reaction:

Al(PO₃)₃+Al₂₋ₓMO₃→Al Al₂₋ₓMPO₄ (II)

where M is Sb, Bi, B, Cr (III), Er, Gd (III), In (III), Ni (III), Rh (III), Sm (III), Sc (III), Tb (III), Ti (III), W (III), V (III), Yb (III), or Y (III); and x is 0, 1, or 2.

The amount of aluminum metaphosphate present to form a matrix around refractory ceramic particulate depends on factors including size of the ceramic particulate, desired interparticle separation, morphology, size of primary crystals and oxide state. Optionally, aluminum metaphosphate is present between 2 and 20 total weight percent of the fully formulated cementitious material casting slurry. Alumina is optionally present in excess of molar stoichiometry of alumina metaphosphate. It is appreciated that alumina is present as aggregate ceramic particles or alternatively is added as a minor quantity of the ceramic particles for reaction with the alumina metaphosphate.

To facilitate mixing of ceramic particle aggregate and alumina metaphosphate as a binder precursor, a quantity of water or organic solvent is added to afford a slurry of a desired viscosity. Such organic solvents illustratively include alcohols, ketones, esters, ethers, amides, amines, glycols, alkanes, and the like. Optionally, such organic solvents are liquids below 200° Celsius, and optionally, are liquids at 20° Celsius. Loadings of water or solvents optionally range from 2-20 total weight percent of a fully formulated cementitious material slurry. Optionally, additives are included that are consumed during berlinite formation, these additives are provided to promote ease of handling. Such additives illustratively include: surfactants; polymerizable organic monomers or oligomers; deflocculants; polymers; and organic acids such as citric, and oxalic. While one of ordinary skill in the art can readily adjust slurry viscosity and green strength through the inclusion of such additives, typically each such additive is present from 0.01-5 total weight percent of a fully formulated refractory composition slurry. It is appreciated that the inclusion of organic monomeric or oligomeric polymerizable materials that upon cure can improve the green strength of the composition prior to firing or reaction may be formed according to Equation (I) or (II). The resultant polymer is decomposed and therefore not present in the resultant refractory composition. Exemplary of such organic polymers are acrylic acids, acrylates, polyethylene glycols, and polycarboxylate ethers, which are added as polymeric precursors or slurry soluble preformed polymers.

Handling properties of a cementitious material slurry and the green strength of a refractory article formed therefrom after drying are also optionally modified through inclusion of nonfacile additives. While the amount of such nonfacile additives is controlled by factors including desired green strength, refractory composition, working environment, temperature and corrosivity, desired cold crush strength, and setting time, working time and curing time, typical loadings of such nonfacile additives range from 0.1 to 10 total weight percent of a fully formulated cementitious material slurry. Representative nonfacile additives operative herein include calcium aluminate cement, sodium silicate, fumed silica, alkali metal or alkali earth polyphosphates, and organic salts like citric, oxalic or nitric acids, calcium silicate cement, potassium silicate, lithium silicate. Optionally, a nonfacile additive is present in a quantity such that the aluminum orthophosphate forms a continuous matrix phase.

Ceramic particle aggregate embedded within an aluminum orthophosphate binder is limited only by the desired properties of the resultant cementitious material and compatibility with aluminum orthophosphate binder. Operative ceramic particle aggregates illustratively include bauxite, tabular alumina, mullite, silicon carbide, fused silica, rutile, andalusite, sillimanite, magnesite, forsterite, kyanite, Mg spinell, and chromium oxide. Typical loadings of aggregate ceramic particles range from 50-95 weight percent of a fully formulated refractory composition slurry. Typical aggregate particle sizes range from 0.1 to 1000 microns. It is appreciated that the aggregate particles can be in a variety of forms including spherical, polyhedral, irregular, and combinations thereof.

A cementitious material optionally includes strengthening fibers such as steel fibers as detailed in U.S. Pat. No. 4,366,255. Additional, illustrative reinforcing fibers include nickel and chromium fibers and synthetic fibers such as polypropylene (PP), polyethylene (PE), and polyethylene terephthalate (PET). Optionally steel fibers are used that contain aluminum within the steel alloy to form a protective layer of alumina on the steel fiber at elevated temperature. Optionally, the steel fiber has from 0.05 to 8 atomic percent aluminum content. Other strengthening fiber fillers operative herein include carbon fibers with the recognition that firing occurs in a reducing atmosphere. Typical loadings of fibers are from 0 to 50 total weight percent of a refractory composition used to make a refractory article.

A cementitious material used to form a refractory article optionally includes one or more aggregate components. An aggregate component is typically present from 50 to 95 total dry weight percent. Typical aggregates illustratively include: flint clay, mulcoa, basalt, olivine, diatomite, vermiculite, perlite, molochite, gibbsite, kyanite, mullite, chromite, tabular alumina, silicon oxide, silica, calcined bauxite, chrome oxide, zirconia, phosphate rock, and mixtures thereof.

A refractory article is optionally cast from a variety of cementitious refractory materials including or other than those disclosed herein such as a variety commercially available materials from Stellar Materials, Inc., Boca Raton., Fla., illustratively Thermbond 7004 or Thermblock 85. Illustrative examples of materials and methods of their production can be found in U.S. Pat. Nos. 6,447,596; and 5,888,292.

The refractory article, depending on particulars of the shape, is readily cast from two part or multiple part molds through techniques conventional to the art.

Among the many challenges for refractory maintenance in aluminum furnaces, for example, are flux salt infiltrations in the belly band area. In prior systems, flux salts like NaCl/KCl/AlF mixtures are overheated and penetrate the entire refractory article and migrate to the back-up lining. The presence of these flux salts dramatically increases the difficulty of repair or maintenance of the refractory lining in a high temperature vessel. The refractory articles presented herein solve this problem by coating the cold face or back of the article (second face) with a high temperature ceramic glaze to form a coated cementitious refractory article. The glaze is impermeable to flux salts even at standard operating temperatures such as those found in a kiln, incinerator, or molten metal vessel. While the refractory material used to form a refractory article may still be infiltrated by molten salt, the presence of the glaze on the cold side contains the flux salts thereby protecting a back-up lining and underlying vessel wall. Thus, when the need arises, a refractory article or wall can be replaced without potential impaired adherence of the new article due to infiltrated flux salt. One advantage of a glaze on the second face of the article is that the glaze cannot be washed off or worn by molten aluminum or other material contacting the hot face. With a thermal gradient provided by the refractory material in the refractory article, the glaze is exposed to more moderate temperature thereby increasing its thermal stability.

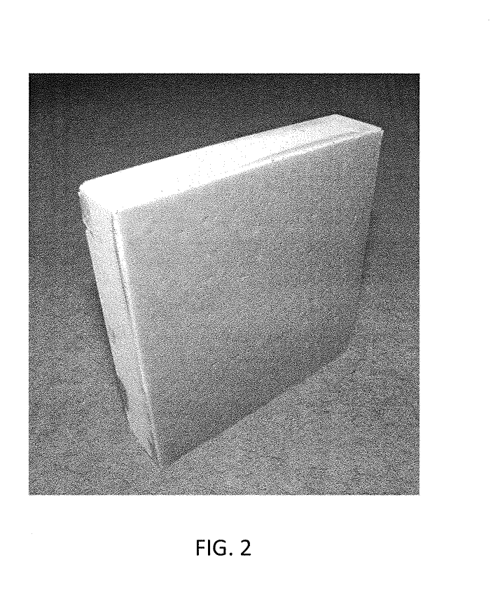

A glaze material coats a portion or all of at least one side of a refractory article. A glaze material may coat a face, an edge, or both a face and an edge, or portion of a face or edge. In some embodiments, glaze material is absent from a first face (hot face). In some embodiments a glaze material is absent from an edge. In some embodiments, a glaze material is absent from a first face and all edges. It is preferred that a glaze material coat a second face, or portion thereof, which is oriented toward or intended to be oriented toward a vessel wall or backup lining. In some embodiments, a glaze material coats an article as depicted in FIG. 2. It is appreciated that a glaze material optionally coats a portion of a face. Optionally, a glaze material coats a region that is central to a face between two opposing edges. Illustratively, a glaze material is intended to be present behind the region of the article that is to lie in the belly band area after installation. It is common to include an amount of molten material in a high temperature vessel such that the area of a belly band has a width that is less than the width of a refractory article. The glaze material optionally is coated only in a region of a refractory article that is expected to lie in this belly band area. Optionally, a glaze material is present on a face of an article in a stripe with a width of 1 inch to 12 inches or any value or range therebetween. The width of a stripe of glaze material is optionally 1, 2, 3, 4, 5, 6, 7, 8, 9, 10, 11, or 12 inches. Optionally, glaze material coats the entire face surface.

A glaze material optionally has a melting point that is or is in excess of 1850° F., optionally at or in excess of 2100° F. The intended use for a refractory article may dictate the melting temperature of the glaze. For example, a use such as a in the lining of a kiln can use a glaze with a lower melting temperature relative to that of a use in a molten metal vessel.

A glaze material optionally is a silica based material. Silica is optionally provided by silica, ball clay, kolin, or fieldspar. In some instances silica is in the faun of free silica, silicon carbide, or combinations thereof.

In some embodiments, a glaze material includes a mixture of silica, silicon carbide, and one or more metal oxides. Such a material is formed by combining free silica with silicon carbide including sufficient soda content and water to form a stiff dough, and allowing the free silica to react with with the soda to form a substance having the desired stiffness. Illustrative examples of such glaze materials are presented in U.S. Pat. No. 2,106,879.

A glaze material may include alumina. Any suitable source of alumina may be used depending on the final application. Illustrative examples of sources that include alumina are ball clay, kaolin, and fieldspar. Other alumina sources are similarly operable.

A glaze material optionally includes one or more metal oxides. Illustrative examples of a metal oxide include Na₂O, Si₂O, K₂O, and Ca₂O, among others. A glaze material optionally contains one or more flux agents. Illustrative examples of a flux agent include calcium carbonate, dolomite, calcium oxide, organic ashes, and barium carbonate, among others known in the art.

Glaze materials useful for coating one or more sides of a refractory article are readily available in the art. One particular example of a glaze includes 45% Sodium Feldspar (NaAlSi₃O₈), 8% Kaolin (2 Al₂Si₂O₅(OH)₄), 17% CaCO₃, 5% ZnO, and 25% SiO₂.

The coated refractory articles can be made in different designs. Shape variations for sills, jambs, lintels and for other molten metal containing vessels like ladles, launder sections and troughs are possible.

The combination of a coated refractory article with a bonding material used as an adhesive mortar suitable to chemically bond to the refractory material of the refractory article, makes it possible to hold a coated refractory article in place with the advantage of having a very efficient non-wetting safety lining in combination with a high wear resistant hot face. As such, a refractory system useful for the formation or replacement of a refractory lining for a high temperature application vessel is also provided. A refractory system comprises a coated refractory article and a complimentary adhesive mortar, optionally a phosphate cement based adhesive mortar. The complimentary adhesive mortar is refractory itself such that the combination of the chemical bonding to the refractory material of the refractory article along with the refractory nature of the adhesive mortar produces a substantially monolithic system that does not suffer mortar wear of prior brick systems, is substantially monolithic after assembly, will not allow flux salts to penetrate the refractory article, and thereby forms a strong, long lasting repair system for high temperature vessels. Such a system may be provided as a two part system including an uncured adhesive mortar, or in combination in final cured form whereby the adhesive mortar is cured in association with a coated refractory article to form a combination of a chemical adhesion with mechanical adhesion, in some embodiments.

An adhesive mortar is optionally formed from a phosphate based component and an alkali earth component. Such a material is capable of chemically reacting with a phosphate bonded cementitious refractory material of a refractory article. An exemplary phosphate based component includes an aqueous acidic phosphoric acid, calcium phosphate, potassium phosphate, magnesium phosphate, sodium phosphate, aluminum phosphate, ammonium phosphate, zinc phosphate, boron phosphate, and combinations thereof.

In some particular embodiments, the alkali earth ion component of an adhesive mortar has as magnesium oxide alone or in combination with a calcium aluminate calcium ion source. The calcium aluminate is optionally dodeca-calcium hepta-aluminate, or tricalcium aluminate. The magnesium oxide is optionally fused and crushed to a size of less than 200 microns.

An alkali earth ion component optionally includes magnesium oxide, dolomite, zinc oxide, aluminum oxide, calcium oxide, lithium carbonate, barium carbonate, barium sulfate, molybdenum oxide, calcium hydroxide, aluminum hydroxide, tin oxide, nickel oxide, nickel hydroxide, cobalt oxide, cobalt hydroxide, vanadium oxide, magnesium hydroxide, iron oxide, titanium oxide, chromium oxide, chromium hydroxide, dolomite, manganese oxide, zirconium oxide, zirconium hydroxide, NaOH, KOH, sodium carbonate, and potassium carbonate.

The alkali earth ion component may be predominantly dodeca-calcium hepta-aluminate (C₁A_{O} or mayenite), tricalcium aluminate (C₃A), or a combination thereof. The calcium aluminate optionally has a mean particle size of less than 100 microns, optionally 60 microns or less. In some embodiments, loadings of C₁₂A₇ in a fully formulated adhesive mortar inclusive of aggregate is from 0.5 to 5 total weight percent with C₁₂A₇ typically being present at about one-fourth the weight percent of CA and/or CA₂ calcium aluminate used in other cementitious materials. C₃A is optionally present from 0.3 to 4 total dry weight percent.

Other materials that may be included in an adhesive mortar are illustratively one or more tackifiers such as: carbohydrates such as saccharides and polysaccharides; starch and derivatives such as pregelatinized starch, dextrin, and corn syrup; naphthalene sulfonate formaldehyde condensate polymers; melamine sulfonate formaldehyde condensate polymers; polyhydroxy polycarboxylic compounds such as tartaric acid and mucic acid; lignosulfonic acid; and salts of any of the aforementioned acid moieties of tackifiers. A tackifier is optionally present at 0.01 to 6 total dry weight percent. Plasticizers and strength enhancing agents such as insoluble phosphate are optionally included. Some embodiments include one or more dispersants such as polycarboxylates and conventional surfactants conventional to the field. Optionally a cementitious adhesive mortar includes one or more deflocculants such as a polyalkylene glycol optionally at 0.05 to 1 weight percent.

Particular examples of an adhesive mortar are illustratively those available from Stellar Materials, Boca Raton, Fla., such as the Thermbond Formula series.

An adhesive mortar is used in a thickness that is defined by the intended use. In some examples, an adhesive mortar is used at a thickness of 0.5, 1, 2, 3, 4, 5, 6, 7, 8, 9, 10, or 11 inches, or any value or range between 0.5 and 11 inches. Optionally, an adhesive mortar is used at a thickness from 2 to 11 inches. In particular embodiments, an adhesive mortar is used at a thickness of 3-6 inches.

A total thickness of a coated refractory article and an associated adhesive mortar is optionally from 4 to 15 inches or any value or range therebetween. Optionally, a total thickness is from 6 to 15 inches, 6 to 12 inches, optionally 7 to 10 inches. A total thickness is optionally 4, 5, 6, 7, 8, 9, 10, 11, 12, 13, 14, or 15 inches.

An adhesive mortar is optionally formed from a phosphate based component and an alkali earth component such as that described in U.S. Pat. No. 7,503,974.

In a system the article and mortar are optionally provided as separate portions to be associated during the formation of a refractory surface. A coated refractory article and an adhesive mortar are optionally chemically compatible so as to form a chemically bonded material upon contact and curing of the adhesive mortar. Illustrative examples of a refractory article and adhesive mortar that are chemically as well as mechanically compatible and used in a system include the Thermbond Thermblock refractory tiles and Thermbond Formula adhesive series available from Stellar Materials, Boca Raton, Fla.

Also provided are processes of forming a refractory lining such as may be used in a high temperature application vessel. A process includes associating a coated cementitious refractor article such as any of those described herein and their equivalents with a structure wall. A structure wall may be a molten metal vessel wall, kiln wall, incinerator wall, or a surface of any device, chamber or construction requiring association with a refractory article so as to be protected from heat or other detrimental environmental condition, or a secondary or safety barrier. Associating a coated cementitious refractory article is optionally by direct bonding to a vessel wall or to a banier coating, such as that used as a safety coating on a vessel wall. Association is optionally by mechanical association such as that maintained by complementary shaping, illustratively provided by one or more indentations provided on a second face of a coated refractory article that will serve to hold the article to the mortar absent or in addition to a chemical interaction. A coated cementitious refractory article is optionally contacted with an adhesive mortar that will chemically react with the material used to form a refractory article. By contacting a phosphate bonded cementitious adhesive mortar with a glazed coated cementitious refractory article a particularly strong and penetration resistant substantially monolithic surface can be formed.

A process optionally includes creating a form comprising one or more coated refractive articles, and associating said form with a cementitious adhesive mortar. In some embodiments, a process includes further associating said adhesive mortar with a vessel wall, second refractory material, or both such that said cementitious adhesive mortar may chemically and optionally mechanically bond the coated refractory article to the surface. A form is optionally created of one or more interlocking coated refractory articles. Interlocking is optionally achieved by associating a contour feature on an edge of a first article with a complimentary feature on an edge of a second article. A form may be placed 2 to 11 inches from an underlying surface such as a vessel wall or other surface to which the coated refractory articles are to be bonded to. A form may be associated a vessel wall by a hanger or other connection that separates the form from the vessel wall. The vessel wall, the hanger or both are also optionally coated with a glaze material. Incinerator walls commonly suffer severe corrosion problems. The combination of the glaze materials and the association of the adhesive mortar with the vessel wall prevents such corrosion. An adhesive mortar is then poured or placed in the space between the form and the surface in uncured or partially cured form so as to fill the space. Curing of the adhesive mortar will then serve to bond the coated cementitious refractory articles to the surface, and form a substantially continuous refractive barrier.

An adhesive mortar when used to chemically bond a refractory article(s) will also penetrate into the joints between refractory articles further providing chemical bonding between articles in addition to the mechanical bonding optionally provided by a contour feature(s). Such a system has numerous advantages including overcoming the traditionally weak mortar joints in existing repair or brick refractory linings by creating a substantially monolithic surface.

A process is optionally used in the repair of a refractory surface in need thereof. The coated refractory articles provided herein alone, or combined with an adhesive mortar are particularly suited to repair of a worn or damaged portion of a refractory surface. A process of repair optionally includes repair at a belly band, sill, ramp, jamb, or other region of a refractory surface or structure that requires repair. A process optionally includes removal of damaged, worn, or otherwise less than desirable prior surface material. One or more refractory articles are associated at the location of the removed area and associated with an adhesive mortar to form a repaired surface. The use of a coated cementitious refractory article that is dimensioned as described allows for economical and superior repair of surfaces in need of such repair.

### EXAMPLES

### Example 1

### Bond Strength of Adhesive Mortar Bonded Refractory Articles.

Tests employing different joint surfaces is performed to evaluate the best surface preparation technique of a refractory tile to promote maximum bond strengths when employed in a high temperature vessel such as a molten aluminum furnace. Adherence of a pre-fired crystalline orthophosphate refractory material sold as Thermbond 7004 sold by Stellar Materials, Boca Raton, Fla. to a phosphate based adhesive mortar sold as Formula 2104L by Stellar Materials, Boca Raton, Fla. is subjected to various strength tests. The test method is based on the 4 point bending strengths test to simulate tensile stresses that potentially occur during impact on a tile during cleaning and expansion/contraction movements of the materials at elevated temperature when used to line an aluminum furnace.

The pre-fired tile test specimens formed from Theimbond 7004, Stellar Materials, Boca Raton, Fla. (2×2×4.5; all inches) (or in previously pre-fired state as Thennblock 85 also from Stellar Materials) for modulus of rupture testing were prepared with different surface structures in order to evaluate the influence of the surface properties on the adherence strengths of the adhesive on the specimen. Tiles for testing were pre-fired at 1500° F. for 5 hours. The pre-fired test specimen was then placed into a mold and the adhesive was cast on the pre-fired specimen resulting in composites of 2×2×9 (all inches). The tile surface adhering to the adhesive was either a rough broken surface, a saw cut surface, or a as cast surface with fine content. In order to simulate an green installed or fired condition of the installed tiles, 4 point strengths tests were carried out on green adhesive samples and on fired tile/adhesive composites with the individual surfaces. Each test is performed using three samples. Table 1 summarizes the test results.

TABLE 1
Adherence Tests

| | 1 | 2 | 3 | |
|---|---|---|---|---|
| Specimen | (PSI) | (PSI) | (PSI) | Average |
| Green - broken surface | 1420 | 1560 | 1381 | 1454 |
| Green - saw cut surface | 2040 | 1790 | 2171 | 2000 |
| Green - white surface | 1190 | 1280 | 1381 | 1284 |
| Pre-fired - broken surface | 2170 | 1980 | 2065 | 2072 |
| Pre-fired - saw cut surface | 2610 | 2900 | 1920 | 2477 |
| Pre-fired white surface | 2210 | 2200 | 1776 | 2062 |
| Control | 1170 | 1250 | 1144 | 1188 |

The results indicate that a smooth saw cut surface with aggregate exposed to adhesive results in the best bond properties in both the green and in the fired state. Specimen material cast and adhered to additional specimen material in the absence of any adhesive and fired (control) results in the weakest bond. This specimen pair was only tested in the fired state. The strongest bonding is observed with saw cut samples. This relatively high bonding strengths are likely due to the fact that cutting of the aggregates exposes a more porous inner surface of the aggregate to the wet adhering material during casting thereby resulting in a better chemical bond.

Various modifications of the present invention, in addition to those shown and described herein, will be apparent to those skilled in the art of the above description. Such modifications are also intended to fall within the scope of the appended claims.

It is appreciated that all reagents are obtainable by sources known in the art unless otherwise specified.

Patents and publications mentioned in the specification are indicative of the levels of those skilled in the art to which the invention pertains. These patents and publications are incorporated herein by reference to the same extent as if each individual application or publication was specifically and individually incorporated herein by reference.

1. A process of forming or repairing a structure for use in high temperature applications comprising:
associating a cementitious refractory article with a structure surface;
said cementitious refractory article having a first face and a second face, said second face proximal to said structure surface;
said second face contacting a glaze material, said glaze overlayering at least a portion of said second face.

2. The process of claim 1 wherein said structure surface is located at the belly band area of said structure wall.

3. The process of claim 1 wherein said associating comprises the steps of:
contacting an adhesive mortar with said article, said adhesive mortar positioned between said article and said structure wall, and contacting a second side of said article;
said contacting forming a chemical bond between said article and said adhesive mortar.

4. The process of claim 1 further comprising:
associating a plurality of said cementitious refractory articles edge to edge to create a form, said form spaced apart from a surface to form a space; and
filling said space with an adhesive mortar thereby contacting said adhesive mortar to said plurality of said cementitious refractory articles;
said contacting forming a chemical bond between said article and said adhesive mortar.

5. The process of claim 3 wherein said adhesive mortar comprises:
a phosphate based component of calcium phosphate, phosphoric acid, potassium phosphate, sodium phosphate, aluminum phosphate, ammonium phosphate, zinc phosphate, magnesium phosphate, or combinations thereof; and
an alkali earth ion component.

6. The process of claim 5 wherein said alkali earth ion component comprises magnesium oxide, a combination of magnesium oxide and calcium aluminate, or a calcium aluminate calcium ion source.

7. The process of claim 5 wherein said adhesive mortar further comprises a strength enhancing insoluble phosphate.

8. The process of claim 1 wherein said refractory article comprises:
a plurality of aggregate ceramic particles; and
a binder sintered to said plurality of aggregate ceramic particles, said binder comprising crystalline aluminum orthophosphate distributed in said binder as the result of a reaction of aluminum metaphosphate with alumina.

9. The process of claim 1 wherein said refractory article has a cold crush strength of greater than 100 N/mm².

10. The process of claim 1 wherein said glaze material has a melting point at or above 1850 degrees Fahrenheit.

11. The process of claim 1 wherein said refractory article has a thickness of between 0.5 to 8 inches.

12. The process of claim 1 wherein said refractory article has a first edge and a second edge, said first edge and said second edge has an edge length of between 12 to 36 inches.

13. The process of claim 1 wherein said refractory article comprises a phosphate bonded cementitious refractory material.

14. The process of claim 3 wherein said adhesive mortar comprises a phosphate cement based adhesive mortar.

15. The process of claim 3 wherein said contacting forms a chemical and mechanical bond between said article and said mortar.

16. The process of claim 1 wherein said refractory article comprises a phosphate bonded cementitious refractory material and said adhesive mortar comprises a phosphate cement based adhesive mortar.

17. A refractory article comprising:
a phosphate bonded cementitious refractory material forming a shape having a first face and a second face opposite said first face; and
a glaze material, said glaze material contacting and overlayering at least a portion of said second face of said refractory material.

18. The article claim 17 wherein said refractory material comprises:
a plurality of aggregate ceramic particles; and
a binder sintered to said plurality of aggregate ceramic particles, said binder comprising crystalline aluminum orthophosphate distributed in said binder as the result of reaction of aluminum metaphosphate with alumina.

19. The article of claim 17 wherein said glaze material comprises silica, a metal oxide, alumina, a silicon carbide, or combinations thereof.

20. The article of claim 17 wherein said glaze material has a melting point at or above 1850 degrees Fahrenheit.

21. The article of claim 17 wherein said glaze material coats less than an entire surface of said second face.

22. The article of claim 17 further comprising a first edge and a second edge, said first edge comprising a contour feature, and said second edge comprising a complementary feature.

23. The article of claim 17 wherein said second face further comprises a plurality of indentations having a depth of less than one inch.
